(19) United States
(12) Patent Application Publication
(10) Pub. No.: US 2011/0240670 A1
(43) Pub. Date: Oct. 6, 2011

(54) Disposable Bathroom Hand Towels

(76) Inventor: Wanda Coleman, Tuscaloosa, AL (US)

(21) Appl. No.: 13/053,353

(22) Filed: Mar. 22, 2011

Related U.S. Application Data
(60) Provisional application No. 61/318,883, filed on Mar. 30, 2010.

(51) Int. Cl. A47K 10/24; F16B 47/00

(52) U.S. Cl. 221/46; 248/206.2

(57) ABSTRACT

A disposable hand towel system for a residential bathroom that improves sanitation and hygiene between users. A modular housing dispenses disposable hand towels as an alternative to traditional hand towels or shower towels used to clean and dry hands prior to leaving a bathroom setting. Rather than reusing a single towel placed in a bathroom or water closet, a set of thick, disposable cloth hand towels are provided. A wall-mounted or counter top dispensing container houses the disposable towels and dispenses a single towel at a time. A plurality of holes in the container allow for wall-mounting. Alternatively, a series of suction cups or a high-friction lower surface keeps the container stationary on a counter top. The towels themselves are a thick, soft cloth large enough to effectively dry a user's hands and face without getting saturated, while still thin enough to be disposable after one use.

### CROSS REFERENCE TO RELATED APPLICATION

This application claims the benefit of U.S. Provisional Application No. 61/318,883 filed on Mar. 30, 2010, entitled “Disposable Bathroom Hand Towels”

### BACKGROUND OF THE INVENTION

1. Field of the Invention

The present invention relates to disposable hand towels. More specifically, the present invention relates to disposable hand towels for home use and modular containers therefor.

2. Description of the Prior Art

Paper towels, one-use towels and associated dispensers are well known in the art, and are commonly found in commercial or public rest rooms for cleaning and drying hands. These are generally stacked sheets of paper towels in a rectangular container on a counter top or stand, or in a wall-mounted roll dispenser. The towels themselves are of various sizes and shapes, and varying ply thicknesses. Very few patents are described in the art for disposable hand towels for home use or associated containers with modular dispensing capabilities.

Patents that describe in-home towel dispensers include U.S. Pat. No. 7,296,705 to Boulet-Mazer. This patent describes a hand towel dispenser with varying embodiments, including different mounting structures and dispensing locations. Different types of hand towels are also described, notably rolled and layered towels.

U.S. Pat. No. 6,439,386 to Sauer and U.S. Pat. No. 6,857,540 to Mitchell describe paper tissue dispensers that can be hung from a support structure with different dispensing modes. The support structures are generally toilet paper rolls or similar devices.

U.S. Pat. No. 5,332,118 to Muckenfuhs describes a pop-up dispensing system in which edge portions of adjacent towels are non-parallel when the individual towel sheets are interleaved and folded, providing a system that brings a second sheet to a first position as the first towel is withdrawn from the dispensing system. This describes a mode of dispensing a set of towels that leaves an exposed towel ready for consumption after each successive towel is pulled from the device.

These devices describe different towel dispensing systems and devices known in the art. The disclosed invention differs from these patents in several ways, most notably by providing a sanitary hand towel system for home use that provides a modular housing that is decorative in nature and suitable for residential environments, and one that can be mounted to a vertical wall or placed on a countertop within a bathroom or kitchen setting.

The container dispenses single use towels that promote sanitary conditions in an easily deployable structure that can be modified to mount in a plurality of locations. The towels are housed in a decorative structure and protected from moisture and contact prior to use. Instructions or notifications can be provided on the outer surface of the container to direct employees or family members to use the towels after bathroom use. The use of a disposable towel reduces cross-contamination between bathroom users, and eliminates the need to use a single, community hand towel that gathers germs and requires regular cleaning.

Diseases are transmitted by many different modes. It is possible for a disease to be transmitted from one person to another through germs, bacteria, and viruses, which can land on surfaces and remain infectious for extended periods of time. At any given time, millions of Americans are coughing, sneezing and generally feeling sick. The average person gets several colds a year, with children tending to be more susceptible to accepting and spreading colds. The disclosed invention comprises a line of disposable towels housed and a dispensing unit. These thick towels would be used to dry hands after washing them in the household bathroom sink. After use, the towel can be easily disposed into a trash receptacle. Instead of sharing conventional hand towels between family members, each person has his or her own disposable towel with which to dry their hands. Thus, the Disposable Bathroom Hand Towels help reduce disease transmission by way of germs and bacteria amongst family members and guests.

### SUMMARY OF THE INVENTION

In view of the foregoing disadvantages inherent in the known types of disposable hand towels and dispenser now present in the prior art, the present invention provides a new disposable hand towel and dispenser wherein the same can be utilized for providing convenience for the user when cleaning one's hands and maintaining a sanitary environment within a household.

It is therefore an object of the present invention to provide a disposable hand towel system and container that provides an alternative to a reusable hand towel in a residential bathroom or water closet.

Another object of the present invention is to provide a disposable hand towel system and container that promotes sanitary conditions and prevents germs and bacteria from spreading between users.

Yet another object of the present invention is to provide a decorative container that can be mounted in several locations and provide a secure environment for enclosed hand towels.

Other objects, features and advantages of the present invention will become apparent from the following detailed description taken in conjunction with the accompanying drawings.

### BRIEF DESCRIPTIONS OF THE DRAWINGS

FIG. 1 shows a perspective view of the disposable hand towel system and container.

FIG. 2 shows rear perspective view of the disposable hand towel system with hanging points.

### DETAILED DESCRIPTION OF THE INVENTION

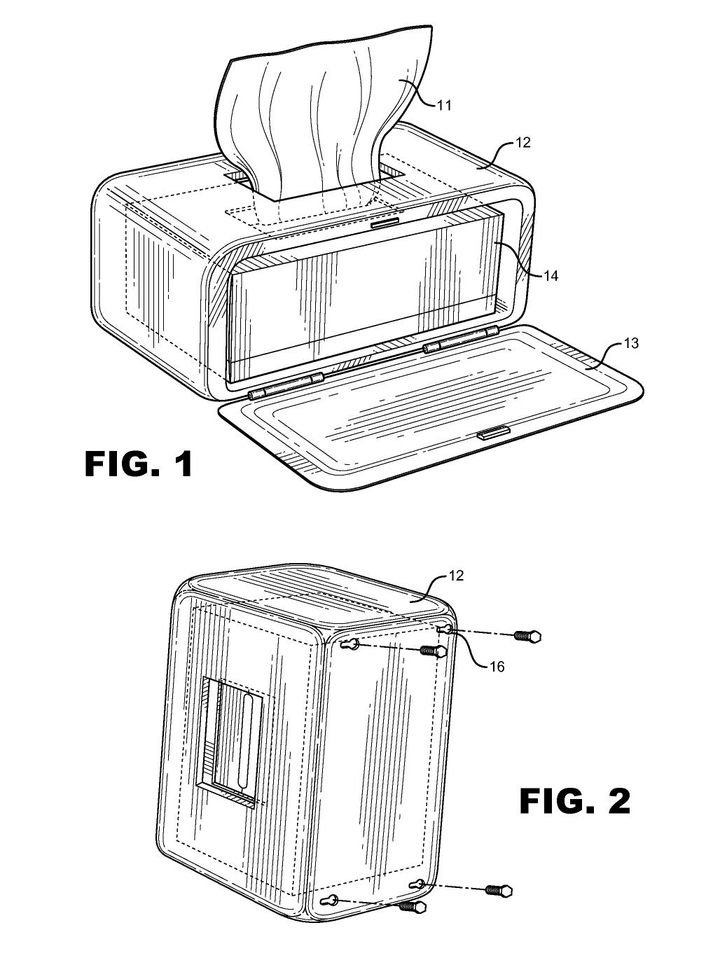

Referring now to FIG. 1, there is shown a perspective view of the disposable hand towels 11 housed inside a dispensing container 12. A plurality of towels 11 are stacked in an interior box that permits the upper most towel to be projected outward from a slot for easy removal. Once a towel is removed, a next towel is pulled into position. A protective cellophane lining is attached around the perimeter of the opening to maintain the integrity of the towels in the box 14. A lid 13 is hingedly attached to the container and encloses the interior box 14, preventing moisture from entering the container and improving its overall aesthetic nature.

Referring now to FIG. 2, there is shown a rear perspective view of the container 12. A plurality of hanging points 16 are provided to mount the container 12 onto a wall for improved access or user preference. In this way, the container can be hung in any orientation preferred, allowing the hand towels to exit the container vertically, horizontally or downwards. The direction may depend on the size and make-up of the room the container is installed in, the size of the individuals reaching for the towels, or general preference of the user with regard to aesthetics. The hanging points are slots that accept a stud or wall nail, and are capable of resisting pull-off loads by transferring bearing forces to the stud or head of the nail.

In use an individual places the container either on a counter top or mounts the container on a wall, places a box of disposable hand towels inside the container, and pulls them from the container for a one-use, disposable alternative to a community towel used for cleaning and drying one's hands. The towels themselves are thick and soft, with a number of plys through the thickness of each sheet. The material is nonabrasive and absorbent, which allows the user to gently wash or dry his or her hands or face without skin irritation and to absorb moisture while drying.

The towels are stacked in sequence inside a replaceable box, similar to a standard box of tissues. The box allows the system to be recharged when all towels are removed from the container. The container can stay mounted to the wall or counter top, and the interior box may be replaced with a fresh set of towels.

Suction cups or a high friction surface is provided along the base of the container to prevent the box from sliding while on a counter top. The container stays stationary and attached to the counter top while towels are pulled from its interior.

The exterior surface of the container may include any decorative pattern or color that suits the user's preferences. The device is intended for in-home use, so aesthetic features are given a higher priority than one that may be used in a commercial or public setting. The dispenser may be formed from injection-molded polystyrene, rough or smooth ceramic, or kiln firing, and produced in a wide range of colors and patterns to compliment a bathroom decor.

The disposable hand towels comprise a line of soft, thick, 2½ ply disposable cloths to be used after washing hands in the home bathroom. Material may include cotton or other soft, absorbent material known to one skilled in the art. Each towel measures approximately 8 inches long by 10 inches wide and may be produced in a wide range of colors, patterns, and designs. The towels are packaged in a cardboard pressboard box, measuring approximately 5 inches wide, 5½ inches tall and 8 inches long. The box may be imprinted in one or more colors with product name, manufacturer, and instructions for use and care.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A disposable, hand towel system for in-home use, comprising:
A rectangular container with a first and second side, an interior space and an elongated slot,
said first side comprises a hingedly attached lid for accessing said interior, and a plurality of wall mounting points line said second side;
a second box of stacked, disposable hand towels interiorly mount inside said interior, access to said towels is obtained through said slot.
said towels are comprised of an absorbent, soft material

2) The device as in claim 1, wherein said container comprises a high friction base surface.

3) The device as in claim 2, wherein said high friction surface comprises a plurality of suction cup devices.
